(19) United States
(12) Patent Application Publication
(10) Pub. No.: US 2008/0154562 A1
(43) Pub. Date: Jun. 26, 2008

(54) High resolution numerical simulations of resuspending gravity currents

(76) Inventors: Francois Blanchette, Mariposa, CA (US); Moshe D. Strauss, Omer (IL); Eckart Heinz Meiburg, Santa Barbara, CA (US); Benjamin Charles Kneller, Aberdeen (GB); Michael Edwin Glinsky, Houston, TX (US)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 11/643,317

(22) Filed: Dec. 21, 2006

(51) Int. Cl. G06G 7/50

(52) U.S. Cl. 703/9

(57) ABSTRACT

A method, apparatus, and article of manufacture provide the ability to determine effects of resuspending gravity currents in a computer system. A slope of a geophysical terrain is determined. A stream function-vorticity description of a fluid motion of a gravity current travelling adjacent to the geophysical terrain is determined. An erosional flux of particles from the geophysical terrain into the gravity current is determined. The particles are incorporated into the gravity current. A description of the gravity current including the incorporated particles is then output (e.g., to a display device).

### BACKGROUND OF THE INVENTION

1. Field of the Invention

The present invention relates generally to sediment deposits, and in particular, to a method, apparatus, and article of manufacture for determining particle deposits in a geophysical context based on turbidity currents and the resuspension of particles in such currents.

2. Description of the Related Art

(Note: This application references a number of different publications as indicated throughout the specification by citations enclosed in brackets, e.g., [x]. A list of these different publications can be found below in the section entitled “References.” Each of these publications is incorporated by reference herein.)

The process of locating an oil reservoir (or oil field) and analyzing its properties is time consuming and costly. Geophysical properties and attributes are often analyzed in an attempt to locate such a reservoir and predict its properties. Many such reservoirs are formed from ancient deposits of sediment. In this regard, particles or grains of sediment are often transported within turbid suspensions into deep water by currents (referred to as turbidity currents, being a class of gravity currents) and eventually settle or are deposited on a bottom surface. Such deposits left by underwater turbidity currents may over time and after deep burial by further sedimentation constitute an oil and gas reservoir. Further, the analysis of particle-laden gravity currents may be used in the research and analysis of the dumping of waste into rivers and oceans. Accordingly, what is needed is the ability to accurately determine and simulate (i.e., produce a model of) particle-laden gravity currents. Such a need and the problems of the prior art may be understood with a description of gravity currents and prior art models/simulations.

Gravity currents are flows generated when a predominantly horizontal density gradient is present in a fluid and hydrostatic pressure differences cause the heavy fluid to spread underneath the light fluid. In geophysical contexts, the density difference between the current and the ambient fluid is often due to the presence of suspended particles which act as the current's driving force. Such particles also settle relative to the fluid and may deposit at the bottom edge of the current. In particular, the dynamics of particle-laden gravity currents are relevant to ash-laden volcanic flows [Sparks et al., 1991], crystal laden flows in magma chambers [Hodson, 1998] and turbidity currents, i.e., underwater currents in which the excess density is provided by suspended sediment [Simpson, 1997].

Erosion by turbidity currents is largely responsible for the creation of submarine canyons on continental slopes [e.g., Pratson and Coakley, 1996]. Turbidity currents are the most significant agents of sediment transport into the deep sea, creating accumulations that include the Earth's largest sediment bodies [Normark et al., 1993]. They also constitute a hazard to marine engineering installations such as oil platforms, pipelines and submarine cables [Krause et al., 1970]. Natural turbidity currents occur infrequently and unpredictably in remote and hostile environments, and tend to be destructive of submarine monitoring equipment [e.g., Zeng et al., 1991]. Consequently they are observed only rarely and generally by indirect means only [Hay et al., 1982; Hughes-Clarke et al., 1990]. Laboratory and numerical experiments thus constitute essential means of investigating these important large scale natural phenomena.

Particle-laden gravity currents have been studied intensively in the past four decades. Turbidity currents are non-conservative in that they entrain ambient fluid through turbulent mixing, and deposit sediment as turbulent motions decay. They may also erode sediment from the bed, thus producing self-sustaining (“autosuspending” or “ignitive”) currents [Parker et al., 1986; Pantin, 1991, 2001]. Simplified analytical models have been suggested to describe density currents [Huppert and Simpson, 1980] and the asymptotic limit of small particle concentration was considered by using density-driven gravity currents as a known background flow [Hogg et al., 2000]. Experimental studies of the progression of particle-laden currents with finite volume [Bonnecaze et al., 1993] or constant flux [Garcia and Parker, 1993] were performed, and particular attention was given to the resulting deposits. Layer-averaged numerical models have been suggested by Bonnecaze et al. [1993] and Garcia and Parker [1993]. Such simplified models require a number of closure assumptions regarding bottom friction, bottom shear stress, fluid entrainment and front velocity. More recently, highly resolved two-dimensional (2-D) and three-dimensional (3-D) simulations computing fluid flow from first principles have successfully described particle-laden gravity currents [Necker et al., 2002]. Several features of the flow, such as energy and particle concentration distribution may easily be computed from these simulations and significantly fewer closure assumptions are required in such models.

The geometry of the surface over which currents propagate determines their long term behavior. For density currents, experimental studies of the influence of the slope angle were performed by Britter and Linden [1980] and Beghin et al. [1981]. Particle-laden currents traveling down a broken slope were investigated by Garcia [1993] owing to their relevance to turbidity currents spreading down the continental shelf before reaching a relatively flat ocean bottom. Complex geometries were recently included in highly resolved simulations via the inclusion of a spatially varying gravity vector in a rectangular computational domain [Blanchette et al., 2005]. If a current is spreading over an erodible bed, the geometry of the base may allow the current to resuspend sufficient particles so that its mass and velocity increase as it progresses down slope. This phenomenon is responsible for the destructive power of avalanches [Hutter, 1996]. Self-sustaining turbidity currents are known to occur in the oceans where they may travel over hundreds of kilometers, as exemplified by the Grand Banks turbidity current of 1929 [Heezen and Ewing, 1952].

The flux of resuspended particles as a function of flow and particle parameters is particularly difficult to estimate. Several empirical models have been suggested [Smith and McLean, 1977; Garci´a and Parker, 1991, 1993], but their applicability remains limited and they must be used with caution. Direct numerical simulations have been employed to study the lift-off of particles in plane Poiseuille flow [Choi and Joseph, 2001], but such simulations are so far limited to a fairly small number of particles arranged in regular patterns [Patankar et al., 2001]. At present, it is fair to say that a complete understanding of resuspension from an irregular bed of particles has not yet been achieved. However, because re-entrainment of particles is critical in the long-term behavior of gravity currents, it must be taken into account despite the limitations inherent in empirical models derived from experimental measurements.

One or more embodiments of the invention focuses on extending earlier high-resolution simulations of non-resuspending turbidity currents [Necker et al., 2002] to situations where resuspension is significant in order to investigate the depositional and erosional properties of such currents. Particular attention may be given to the conditions required for a particle-laden current to exhibit a snow ball effect. Specifically, embodiments question under which conditions a current becomes self-sustaining depending on parameters such as particle size and concentration, current height and slope angle.

### SUMMARY OF THE INVENTION

One or more embodiments of the invention provide a computational model for high-resolution simulations of particle-laden gravity currents. More specifically, embodiments provide the ability to model turbidity currents wherein resuspension of the particles are included in the model. Such resuspension is useful in an investigation of the depositional erosional properties of such currents. Further embodiments describe the conditions required for a particle laden current to become self-sustaining depending on parameters such as particle size and concentration, current height and slope angle.

In view of the above, as turbulent motions detach particles from the bottom surface, resuspended particles entrained over the entire length of the current are transferred to the current's head, causing it to become denser and potentially accelerating the front of the current. The conditions under which turbidity currents may become self-sustaining through particle entrainment are described herein as a function of slope angle, current and particle size, and particle concentration. The effect of computational domain size and initial aspect ratio of the current on the evolution of the current are also considered. Applications to flows traveling over a surface of varying slope angle, such as turbidity currents spreading down the continental slope, are modeled via a spatially varying gravity vector. Resulting particle deposits and erosion patterns may also be evaluated by embodiments of the invention.

### BRIEF DESCRIPTION OF THE DRAWINGS

The file of this patent contains at least one drawing executed in color. Copies of this patent with color drawing(s) will be provided by the patent and Trademark Office upon request and payment of the necessary fee.

Referring now to the drawings in which like reference numbers represent corresponding parts throughout:

FIG. 1 illustrates a schematic of the coordinate system used in simulations in accordance with one or more embodiments of the invention;

FIGS. 2A-2B illustrate typical concentration and vorticity fields associated with a particle-driven current computed via the model in accordance with one or more embodiments of the invention;

FIG. 3 illustrates the time evolution of the position of the front of a density current traveling over a horizontal surface in accordance with one or more embodiments of the invention;

FIG. 4 illustrates the measured length of a density current as a function of time compared to simulations in accordance with one or more embodiments of the invention;

FIG. 5 illustrates simulations computed for identical parameter values in accordance with one or more embodiments of the invention;

FIG. 6 compares the deposit resulting from a particle-driven current to that obtained via simulations in accordance with one or more embodiments of the invention;

FIG. 7A illustrates the time dependence of the front velocity for different values of the computational domain height, for a fixed initial heavy fluid height in accordance with one or more embodiments of the invention;

FIG. 7B illustrates the time dependence of the front velocity for different inclination angles for both shallow and deep ambients in accordance with one or more embodiments of the invention;

FIGS. 8A-8B illustrate the time dependence of the current mass normalized by the initial mass for various initial length at two different inclination angles in accordance with one or more embodiments of the invention;

FIGS. 9A-9F show an example of a strongly resuspending current in accordance with one or more embodiments of the invention;

FIGS. 10A-10F illustrate the evolution of the particle concentration (i.e., FIGS. 10A, 10C, and 10E) and the evolution of bed height and average concentration (i.e., FIGS. 10B, 10D, and 10F), of a nonresuspending gravity current at different times in accordance with one or more embodiments of the invention;

FIGS. 11A and 11B illustrate time dependence of the normalized mass of suspended particles (i.e., FIG. 11A) and front velocity of currents propagating over slopes of various slope angle (i.e., FIG. 11B) in accordance with one or more embodiments of the invention;

FIG. 12A illustrates dependence of the critical self-sustaining angle on the initial heavy fluid height and on the initial particle concentration in accordance with one or more embodiments of the invention;

FIG. 12B illustrates the dependence of the critical angle on particle radius in accordance with one or more embodiments of the invention;

FIGS. 13A-13E show the progression of a current traveling down a broken slope in accordance with one or more embodiments of the invention;

FIG. 14A illustrates front velocity and suspended mass as a function of the position of the nose of a current propagating over a broken slope in accordance with one or more embodiments of the invention;

FIG. 14B illustrates dependence of the deposit height on the distance from the left wall at various times for the same current in accordance with one or more embodiments of the invention;

FIG. 15 is an exemplary hardware and software environment used to implement one or more embodiments of the invention; and

FIG. 16 illustrates the logical flow for determining the effects of resuspending gravity currents in a computer system in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Model Description

Governing Equations and Relevant Parameters

Embodiments of the invention consider currents in which the particle concentration is relatively low, so that particle-particle interactions may be neglected. The density difference between the current and the ambient is thus typically small and the Boussinesq approximation [e.g., Spiegel and Veronis, 1960] may be used, where density variations appear only in the buoyancy term. A continuum approach is used, where the density of the suspension, ρ̅, is related to the particle concentration by volume, C̅, through p̅= p̅_{ƒ}+ C̅( p̅ₚ− p̅_{ƒ}), where p̅_{ƒ} and p̅ₚ are the fluid and particle density, respectively, and the bars indicate dimensional (and non-normalized) quantities. Particles are assumed to be transported by the fluid and to settle relative to the fluid with velocity ūₛ in the direction of gravity.

The work by Necker et al. [2002] comparing 2-D and 3-D simulations of gravity currents showed that, even though vortices tend to be more vigorous in 2-D simulations than in full 3-D simulations, 2-D and 3-D simulations yield very similar results regarding the front propagation velocity and the spanwise averaged deposit profile. For this reason, embodiments of the invention may be restricted to 2-D systems. Pressure terms are eliminated by considering a stream function-vorticity description of the fluid motion. Denoting the coordinate parallel to the bottom surface by x₁, that perpendicular by x₂ and the corresponding velocities by u₁ and u₂ respectively, a stream function ψ may be introduced that satisfies u₁=∂ψ/∂x₂ u₂=−7 ψ/∂x₁ and a vorticity function ω=∂u₂/∂₁−∂u₁/∂x₂.

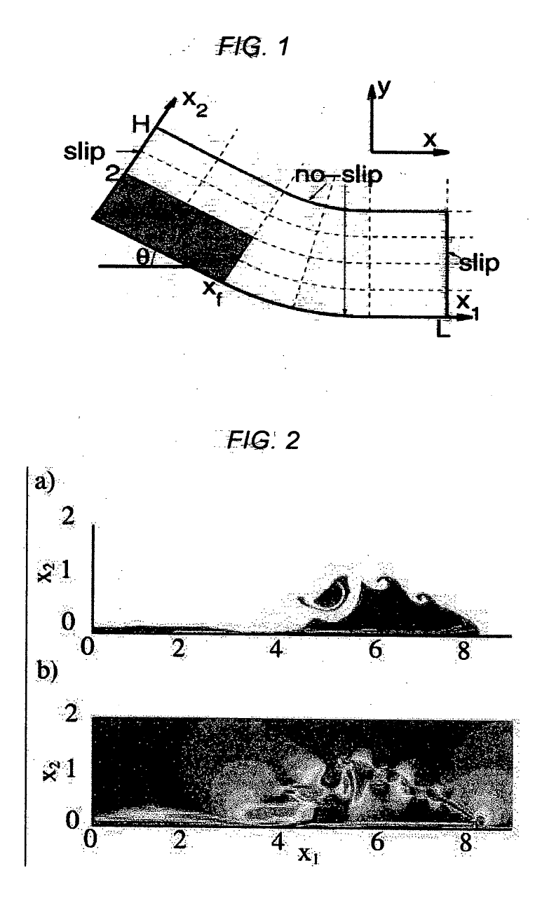

FIG. 1 illustrates a schematic of the coordinate system used in simulations in accordance with one or more embodiments of the invention. The angle θ between the x₁ axis and the horizontal axis is allowed to vary with x₁ to model varying slopes. The dark region corresponds to the initial position of the heavy fluid and is constrained by 0≦x₁≦x_{ƒ},0≦x₂≦2. The height and length of the computational domain are H and L, respectively.

Embodiments of the invention use the initial half-height of the suspension reservoir, h̅, as a length scale, and the initial particle concentration, C̅₀, as a concentration scale. As a typical velocity, the buoyancy velocity is considered as:

ū_{b}=(g h̅C̅₀R)^{1/2}, (1)

where g is the gravitational acceleration and R=( p̅ₚ− p̅_{ƒ})/ p̅_̅{̅ƒ̅}̅. The following nondimensional governing equations may be obtained [Necker et al., 2002]:

$$\begin{matrix}{∇}^{2} ψ = - ω & ( 2 ) \\ \frac{D ω}{Dt} = \frac{{∇}^{2} ω}{Re} - \frac{\partial ( C cos θ )}{\partial {X}_{1}} - \frac{\partial ( C sin θ )}{\partial {x}_{2}} & ( 3 ) \\ \frac{D C}{Dt} + {U}_{s} ( \frac{\partial ( C sin θ )}{\partial {x}_{1}} - \frac{\partial ( C cos θ )}{\partial {x}_{2}} ) = \frac{{∇}^{2} C}{Pe} & ( 4 )\end{matrix}$$

where the notation D/Dt=∂/∂t+u₁/∂x₁+u₂∂/∂x₂ is used and where Uₛ=Ūₛ/ū_{b} h̅/ v̅ is the Reynolds number and and Pe=ū_{b} h̅/ κ̅ the Péclet number, with v̅ the fluid viscosity and κ̅ the particle diffusion constant. Note that the only driving force of the flow comes from horizontal variations of C, i.e., variations along the x axis.

It should be pointed out that, in principle, one can account for the force exerted by the particles onto the fluid in two different ways. In the first approach one considers the conservation equations for the suspension, i.e., the combined fluid/particle system. In this case, only external forces acting on the suspension should be considered, such as the action of the buoyancy force on the density field of the suspension. Internal forces acting within the suspension, such as the drag force between fluid and particles, are not considered separately in this case. This approach was taken by Necker et al. [2002], and is also pursued here. Alternatively, one may consider the fluid and the particles separately. In this case, the conservation equation for the constant density fluid contains a term that accounts for the drag force exerted by the particles on the fluid, but a separate buoyancy force does not appear in the equation. In that sense the drag force and the buoyancy force are equivalent to each other. This second approach was taken, for example, by Bosse et al. [2005].

Simulations of embodiments of the invention aim at reproducing as closely as possible the physical conditions prevailing in large turbidity currents. Accordingly, embodiments simulate currents in which water is the suspending fluid, i.e., p̅_{ƒ}=1 g/cm³ and v̅=10⁻⁶ m²/s. Particles of density p̅ₚ=2.5 g/cm³(R=1.5) and typical diameter d̅=100 μm, values appropriate for sandy turbidity currents such as those forming many submarine fans [Normark et al., 1993] were considered. To compute the particle settling speed, the empirical formula of Dietrich [1982] was employed, Uₛ=(WgR v̅)^{1/3}, where

$$\begin{matrix}W = 1.71 \times {10}^{- 4} ( \frac{gR {\overline{d}}^{3}}{{\overline{v}}^{2}} ) , if λ < - 1.3 \\ = {10}^{p ( λ )} , otherwise ,\end{matrix}$$

with λ=log₁₀(gR d̅³/ v̅²) and

p(λ)=(−3.76715+1.92944λ−0.09815λ²−0.0057λ³+0.00056λ⁴).

To compute the buoyancy velocity, a typical particle concentration of C̅₀=0.5% and height of approximately h̅=1.6 m, were used, which results in a nondimensional particle settling speed of Uₛ=0.02.

The above parameters correspond to a current Reynolds number (Re) of order 10⁶, which is well beyond the current reach of direct numerical simulations. As Re increases, smaller length scales must be resolved, which in turn implies shorter time steps. However, as described below, provided Re>O(1,000), variations in Re only have a small effect on the overall features of the flow, [cf. Parsons and Garcia, 1998]. For this reason, most of the simulations to be discussed below were carried out with a reduced Reynolds number Re ᵣ<<Re which is kept in the range 1,000 <Re_{T}<10,000. This reduced Reynolds number can be interpreted as a simple way to model the effects of small-scale, unresolved flow structures.

A focus of embodiments of the invention is on small particles with negligible inertia, whose velocity is given by the fluid velocity and a superimposed settling velocity. Hence it is reasonable to assume that the small-scale, unresolved flow structures will affect the transport of particles in the same way as the transport of fluid [Shraiman and Siggia, 2000], so that the value of the reduced Péclet number Pe_{T} is set equal to that of the reduced Reynolds number. Note that all other dimensionless parameters are kept at their original values for the typical turbidity current described above. While turbulence models have been developed for variable density [Speziale, 1991; Choi and Garci´a, 2002] and particle-laden flows [Elghobashi and Abouarab, 1983; Hagatun and Eidsvik, 1986; Zhang and Reese, 2001; Hsu et al., 2003, and others], there are no models that can accurately capture the complex physics in the nondilute layer next to a resuspending particle bed.

A lock-release model may be analyzed, where heavy fluid is initially confined to a small region, 0≦x₁≦x_{ƒ} and 0≦x₂≦2. The initial length of the current, x_{ƒ}, may be varied but was usually kept at x_{ƒ}=2. For reasons of numerical stability, the initial concentration profile was smoothed over a few grid points (typically 6) using an error function centered at x₁=x_{ƒ} in the horizontal and at x₂=2 in the vertical. The fluid is initially at rest, ψ=ω=0 and starts moving at t=0.

In order to model complex geometries, a spatially varying gravity vector is used [Blanchette et al., 2005]. A curvilinear coordinate system is thus simulated but second order curvature terms are neglected. The resulting approximation is expected to be valid if the ratio of the height of the flow to the radius of curvature of the bottom surface is everywhere small. The study may be restricted to smoothly varying bottom surfaces to ensure that the neglected curvature effects remain small. A rectangular computational domain may be used and enforce a no-slip, no normal flow condition at the top and bottom boundaries, ψ=∂ψ/∂x₂=0, and a slip, no normal flow condition at the left and right walls, ψ=∂²ψ/∂x₁²=0. The latter conditions allow for the use of fast Fourier transforms in the x₁ direction which provides high accuracy to the numerical scheme.

The particle concentration flux at the boundaries, F, is set to zero at the top and left walls. At the right wall, which effectively is never reached by the heavy current, particles may deposit, but no resuspension is allowed so that F=−CUₛ sin θ. However, particles are allowed to deposit and reenter suspension at the bottom boundary: F=(−CUₛ cos θ+EₛUₛ), where Eₛ is a measure of the resuspension flux as discussed below. Thus at the top and left boundaries, the diffusive flux is equal to the settling flux, it is zero at the right wall and it is equal to the resuspension flux at the bottom surface:

$$\begin{matrix}{CU}_{s} cos θ + \frac{1}{{Pe}_{T}} \frac{\partial C}{\partial {x}_{2}} = 0 \\ \text{at} \\ {x}_{2} = H , & ( 5 ) \\ - {CU}_{s} sin θ + \frac{1}{{Pe}_{T}} \frac{\partial C}{\partial {x}_{1}} = 0 \\ at \\ {x}_{1} = 0 , & ( 6 ) \\ \frac{\partial C}{\partial {x}_{1}} = 0 \\ at \\ {x}_{1} = L , & ( 7 ) \\ \frac{\partial C}{\partial {x}_{2}} = - {Pe}_{T} {U}_{s} {E}_{s} \\ at \\ {x}_{2} = 0. & ( 8 )\end{matrix}$$

Unresolved turbulent motions are assumed to be responsible for resuspending particles near the bottom boundary. The influx of particles due to resuspension is therefore modeled as a turbulent diffusive flux, as small scale turbulent motions bring deposited particles into the suspension. As compared to the frequently employed strategy of distributing the added particles equally over the entire height of the current, this diffusive flux approach represents a more realistic approximation of the physically complex resuspension process. The height of the deposit, d(x₁, t), may be found by integrating the particle flux over time

$$d ( {x}_{1} , t ) = \frac{\overline{{C}_{0}}}{σ} {\int }_{0}^{t} ( {CU}_{s} cos θ {\vert}_{x 2 = 0} - {E}_{s} {U}_{s} ) d t ,$$

where σ is the particle volume fraction in the bed, taken to be a constant σ=0.63 [Torquato et al., 2000]. Note that the corresponding porosity of the deposit is 1−σ=0.037. Note that embodiments may consider only flows where C̅₀˜1% so that the erosion or deposition depth is small relative to the current size (d<<H), which allows one to keep the position of the bottom boundary fixed in computations.

To evaluate the resuspension flux, Eₛ Uₛ, the empirical formula derived by Garcia and Parker [1993] can be used for turbidity current experiments, which relates the resuspension flux to the particle Reynolds number and bottom shear velocity. An erodible bed composed of particles identical to those in suspension is considered. A measure of the vigor of the resuspension is given by Z, which, following Garcia and Parker [1993], is defined as:

$$Z = \frac{{u}^{*}}{{U}_{s}} {Re}_{p}^{0.6} if {Re}_{p} > 2.36 , \\ Z = 0.586 \frac{{u}^{*}}{{U}_{s}} {Re}_{p}^{1.23} if {Re}_{p} \leq 2.36$$

where u* is the shear velocity at the bottom wall and Reₚ is the particle Reynolds number

$${u}^{*} = {( \frac{1}{{Re}_{r}} \frac{\partial u}{\partial {x}_{2}} {\vert}_{x 2 = 0} )}^{1 / 2} , \\ {Re}_{p} = \frac{{\overline{d} ( g \overline{d} R )}^{1 / 2}}{\overline{v}} . \qquad ( 9 )$$

The lower and upper branches of Z reflect the different settling dynamics of low and high particle Reynolds numbers, respectively. The resuspension flux, Eₛ Uₛ, is then a threshold function of Z,

$${E}_{s} = \frac{1}{{\overline{C}}_{0}} \frac{{aZ}^{5}}{1 + \frac{a}{0.3} {Z}^{5}} , \qquad ( 10 )$$

with a=1.3×10⁻⁷. Notice that the normalization of Eₛ by the initial particle concentration renders the effect of resuspension more significant for dilute suspensions. Also, Eₛ may not exceed 0.3/ C̅₀, thus providing a saturation mechanism.

Modeling resuspension as a turbulent diffusive flux has the inconvenience of injecting energy into the current through particle diffusion: particles are lifted upward by diffusive effects without a corresponding energy loss. For small inclination angles and particle settling speed, (θ≦2°, Uₛ≦0.005), this diffusive energy input may significantly affect the dynamics of the flow. For flat surfaces and small particle settling speeds, a more detailed description of the turbulence, such as that provided by a K-ε model [Speziale, 1991], may help to account for this energy input by decreasing the turbulent kinetic energy. However, for larger slope angles, the potential energy lost or gained by the current through the deposition or resuspension of particles located higher than the downstream bottom boundary is much larger than that gained through particle diffusion. The dynamics of the flow are therefore dominated by the potential energy of deposited or resuspended particles and a model of the invention is expected to adequately describe currents evolving over sufficiently large slopes. Similarly, for large settling speeds, the energy lost through particle settling is dominant and the invention may be expected to correctly capture the main features of the flow.

Numerical Approach

The numerical integration of equations (2)-(4) may be performed in a manner similar to that of Hartel et al. [2000]. A Fourier transform is performed for ψ in the x₁ direction and use sixth-order compact finite differences for other derivatives, except near the boundaries where the derivatives are accurate to third order [Lele, 1992]. A third-order Runge-Kutta integrator is used to march equations (3)-(4) forward in time [Hartel et al., 2000]. The velocity field is obtained by differentiating ψ. An adaptive time step is used to satisfy the Courant-Friedrichs-Levy and diffusive stability criteria while minimizing computation time. The governing equations are solved over a rectangular domain described by 0≦x₁≦L, 0≦x₂≦H, with typical values L=24 and H=4 and a grid of size 1025×385, which has been shown to be a sufficient resolution [Blanchette et al., 2005]. The flow is found to be unaffected by the choice of L as long as the tip of the current remains more than one nondimensional unit away from the right wall. Embodiments investigate the influence of H in the following section.

Large concentration derivatives near the bottom boundary may result from the modeling of resuspension as a diffusive flux. A finer grid is thus required near the bed than in other areas of the computational domain. To accelerate computations, embodiments have implemented an unevenly spaced grid in the x₂ direction. By considering a Taylor series expansion, the compact finite differences formulas presented in the work of Lele [1992] may be generalized to allow for the use of a varying Δx₂. An example of the resulting formula used to compute a first derivative is shown in Appendix A. The obtained formulas are sixth-order accurate and their local error scales as the sixth power of the local Δx₂. To determine the position of the grid points, x₂^{j}, embodiments evenly space grid points on a stretching variable 0≦s^{j}≦1 and use a mapping function of the form [Fletcher, 1991]

$${x}_{2}^{j} = H \frac{tanh ( α ( {s}^{j} - 1 ) ) + β {s}^{j} + tanh ( α )}{tanh ( α ) + β}$$

where typical values of the coefficients are α=3 and β=0.32. These values yield Δx₂=0.0028 and Δx₂=0.026 near the bottom and top wall, respectively, with a continuous variation in the central region. Validation information is described below as part of the next section.

### Simulation Results

FIG. 2 illustrates typical concentration and vorticity fields associated with a particle-driven current computed via the model in accordance with one or more embodiments of the invention. FIG. 2A shows a sample of the concentration and FIG. 2B shows a sample of vorticity of a particle-driven current traveling over a surface with an inclination angle θ=5°, at t=7.5 computed via a numerical model of an embodiment of the invention. In FIG. 2A, the color code is: 0.1<C ≦0.5 yellow, 0.5<C≦0.8 green, 0.8<C≦1 red, 1<C≦3 cyan, and 3<C black. In FIG. 2B, positive (counterclockwise), zero, and negative (clockwise) vorticity are shown in red, green, and blue, respectively. The simulation parameters are

H=4, L=24, x_{ƒ}=2, Uₛ=0.02, Reₚ=3.83, and Re_{T}=Pe_{T}=2,200.

In other words, the current is traveling over a surface with a relatively large slope angle, θ=5°, and is therefore predominantly erosional. Resuspension increases the particle concentration near the bottom boundary (blue and black zones) to a level exceeding the initial concentration C=1. Vortices are shed behind the head of the current and form nearly circular regions of nonzero particle concentration (e.g., yellow and green in FIG. 2A) embedded in ambient fluid. Such vortices generate mixing with ambient fluid, causing the particle concentration to decrease below its initial value. They are also responsible for a significant fraction of the viscous energy dissipation and therefore act to reduce the kinetic energy of the current. The largest vorticity is found near the bottom boundary due to the no-slip boundary condition. The bottom shear stress is sufficiently large to cause particles to be re-entrained. Behind the head of the current, vortices are seen to vertically mix the particle concentration. Fluid in the rear of the current tends to catch up with the front [Hartel et al., 2000], causing high particle concentrations to develop near the head.

Influence of the Reduced Reynolds and Péclet Numbers

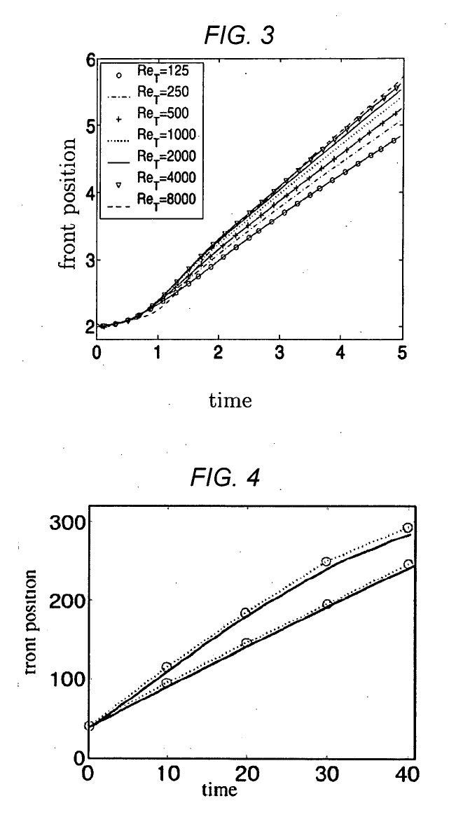

The impact of the reduced Reynolds number used in the simulations on the main features of the flow may be examined. FIG. 3 illustrates the time evolution of the position of the front of a density current (Uₛ=0) traveling over a horizontal surface in accordance with one or more embodiments of the invention. For relatively small reduced Reynolds numbers, Re_{T}<1,000, the front velocity increases significantly with Re_{T}. However this dependence becomes negligible for larger reduced Reynolds numbers. For sufficiently large values of Re_{T}, other qualitative features of the flow, such as the shape and number of vortices shed behind the head or the size of the head, were also observed to be nearly independent of Re_{T}, which validates the use of a reduced Reynolds number, provided Re_{T}>1,000. Thus, FIG. 3 illustrates the time-dependence of the front position of a density current (Uₛ=0) traveling over a horizontal surfaced for various values of the reduced Reynolds number. For Re_{T}≧0(1,000), the front velocity becomes nearly independent of Re_{T}. Other parameters are x_{ƒ}=2, H=4, L=12, and Pe_{T}=Re_{T}.

The value of Re_{T} only has a week influence on the resuspension model. The nondimensional bottom shear velocity near a solid wall, u*, is known to decrease logarithmically with increasing Reynolds number [Barenblatt, 1993], which tends to reduce resuspension for large values of Re_{T}. This may be understood by noting in equation (9) that u*˜1/Re_{T} so that even though larger Re_{T} generate larger ∂u/∂x₂, the net effect of increasing the Reynolds number is to decrease u*. However, because of the logarithmic dependence of u* on Re_{T}, little effect was observed in simulations. The above resuspension model also depends on Pe_{T}, as particles resuspended from the bed are distributed over a layer of thickness δᵣ˜Pe_{T}^{-1/2}. The influence on resuspension of Pe_{T} is analogous to that of the ratio, r₀, of the particle concentration near the bed to the average concentration in the current of layer averaged models [Parker et al., 1987]. A suitable value of Pe_{T} can be determined from experimental measurements of r₀. Data provided by Garcia [1994] suggest that r₀=2, which is approximately reproduced in simulations for Pe_{T}=2,200, a value which will be used henceforth. Further comparisons between our simulations and experiments are discussed in the next section.

It should be noted that quantitatively similar results were obtained from a cruder resuspension model. In preliminary simulations, the diffusive flux at the bottom boundary was set to zero, and resuspended particles were simply added uniformly over a layer of uniform thickness, δᵣ≈0.1, near the bottom boundary. The added mass of resuspended particles was computed at every time step, Mᵣ(x₁)=EₛUₛΔt, and the concentration was increased in the resuspension layer

C(x₁, x₂, t)=C¹(x₁, x₂, t)+Mᵣ/δᵣ, if 0<x₂<δᵣ

where C′ was obtained by advancing in time equations (2)-(4). The general features of the flow agreed well with those observed when particles are resuspended through a diffusive flux. The dependence on Re_{T} was similar in both models and increasing δᵣ was analogous to reducing Pe_{T}. Keeping in mind that even the strategy of distributing resuspended particles over the entire current height has been successfully used in layer averaged models [cf. Garcia, 1994], it can be hence be concluded that the dominant features of the flow, and in particular whether or not a flow is self-sustaining, are largely independent of the details of the resuspension model.

Comparison With Experiments

This section presents a comparison between numerical simulations and experimental data published in the literature. FIG. 4 illustrates the measured length of a density current (Uₛ=0) as a function of time compared to simulations in accordance with one or more embodiments of the invention. The experimental results displayed in FIG. 4 were obtained by Huppert and Simpson [1980] and corresponding governing parameters are used in the comparative simulations, Re=6300. In particular, the nondimensional height of the container is H=5.87, which ensures that the influence of the top surface on the propagation of the current is minimal. The time-dependent position of the front, and consequently the speed of density current, is seen to be accurately reproduced by the simulation. Experiment and simulation are seen to agree well for more than 30 nondimensional time units, by which time the current has lost most of its structure. This comparison demonstrates the ability of the simulations to reproduce the front velocity.

Accordingly, FIG. 4 illustrates the comparison of the position of the front of a density current as a function of time measured experimentally by Huppert and Simpson [1980] (circles) with that computed via simulations of the invention (solid line). In nondimensional form, the parameters used are: H=5.87, C₀=0.0096, x_{ƒ}=5.21, and Re=6300, and experiments are nondimensionalized using typical length and time L=7.5 cm and t=0.89 s. There are no free parameters in the simulations.

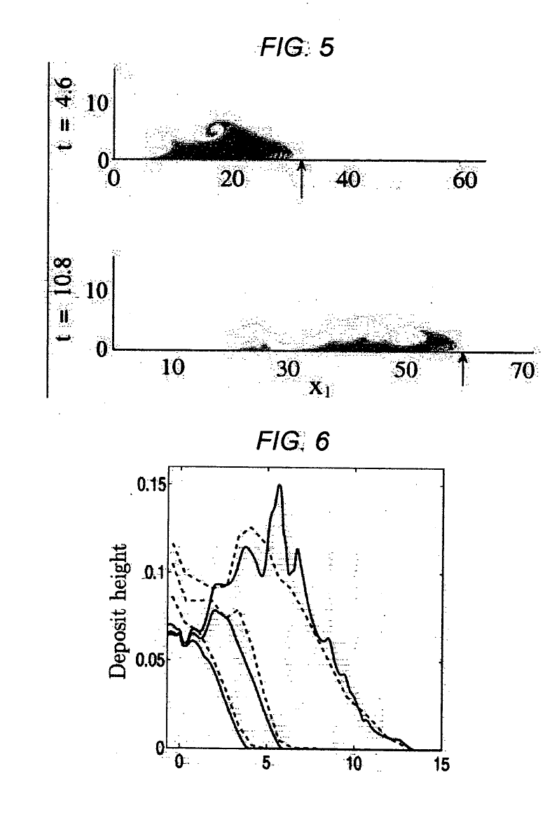

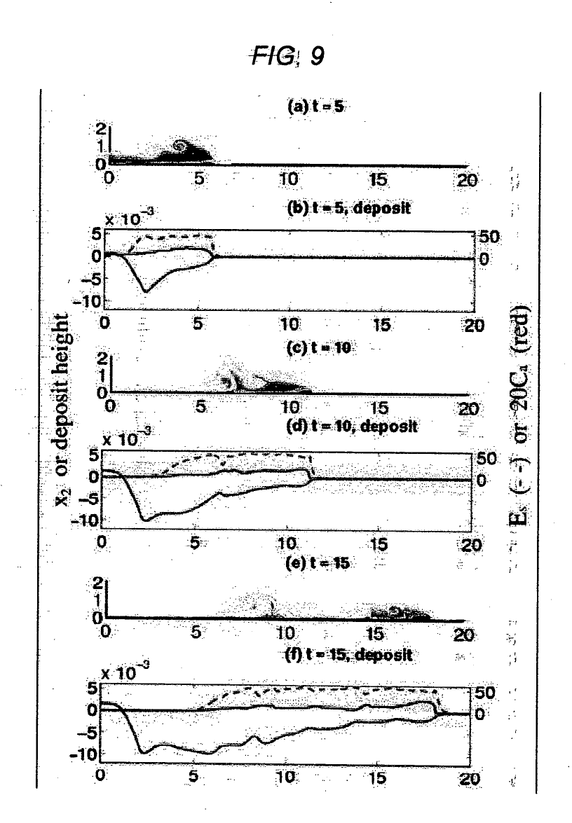

A comparison of the progression of particle-laden currents can also be examined. In this context, experiments are constrained by the necessity to maintain particles in suspension before the lock is released. Therefore, experiments are usually performed in a shallow ambient, and with a free surface. The fact that the top surface is modeled as a no-slip wall rather than a free surface is expected to cause more substantial discrepancies between experiments and simulations because simulations cannot capture the vertical displacement of the top surface. FIG. 5 illustrates simulations computed for identical parameter values in accordance with one or more embodiments of the invention (e.g., which may be similar to experiments of Bonnecaze et al. [1993, FIG. 9A]). In FIG. 5, the concentration of a particle-laden current is shown at two different times. The arrows indicate the front position recorded in the experiment at corresponding times. The experiments show some 3-D turbulence and were performed at higher Reynolds number (≈7,600) than the simulations (Re_{T}=2,200). Nevertheless, the concentration field shown in FIG. 5 exhibits good agreement with the experiments, which further justifies the use of a reduced Reynolds number value. In particular, the general shape, length, and consequently velocity, of the current are rather well reproduced.

The bore described by Bonnecaze et al. [1993] due to the reflection of light fluid off the back wall may also be observed in the simulations and is responsible for the separation between the suspension and the left wall. In simulations, the bore appears to travel somewhat faster than in the corresponding experiments. The difference in bore velocity may be due to assumption of a no-slip top boundary rather than a free surface. A model of an embodiment of the invention therefore does not accurately reproduce the effects of the light fluid backflow. However, with the exception of the progression of the bore, the main features of the particle driven current are adequately captured by the model and one may therefore expect that in a deep ambient, where no bore is present, a model would describe particle-laden currents more accurately, as was the case for density currents. It should be noted that in the experiments, the bottom surface was a solid wall and any resuspension below the original level of the bottom wall was prevented in the simulations.

Thus, FIG. 5 shows the progression of a particle-laden current with governing parameters identical to those of the current shown in the work of Bonnecase et al. [1993, FIG. 9A]. The arrows indicate the position of the front recorded in the experiment. In nondimensional form, the parameters used are: H=2, Uₛ=0.03, x_{ƒ}=1.14, and Reₚ=1.8, and experiments are nondimensionalized using typical length and time L=7 cm and t=0.64 s. The experimental Reynolds number is Re=7600; simulations were performed with a reduced value Re_{T}=2200.

FIG. 6 compares the deposit resulting from a particle-driven current to that obtained via simulations in accordance with one or more embodiments of the invention. In FIG. 6, the experimental results of De Rooij and Dalziel [2001] are compared to a computed deposit for a current with corresponding parameters. Simulations of the embodiments of the invention again make use of a reduced Reynolds number (2,200 compared to 10,000 in the experiment) and are purely 2-D while the experiments were conducted in a channel of width comparable to its height. The results are seen to be in fairly good agreement as to the extent and elevation of the deposit. Differences are largest near the left hand wall and are probably attributable to variations in the initial conditions: in the experiments particles are kept in suspension by continuous stirring before the lock is released while in simulations, the suspension is initially quiescent. The simulations are also seen to yield more local variations in the deposit height. Such oscillations result from eddies generated at the top of the current by the strong fluid backflow present in a shallow ambient. Once again, the top surface was free in the experiments, which acts to reduce the shear and thus the formation of stationary eddies. It should be pointed out that a similar comparison was presented by Necker et al. [2002]. Their simulations were based on similar equations but did not include resuspension or slope variations. Both set of simulations agree with the experiments because resuspension was in fact negligible in the experimental results of De Rooij and Dalziel [2001]. Note also that Necker et al. [2002] also looked at deposits obtained via 3-D simulations and found negligible differences with those computed with a 2-D code.

Thus, FIG. 6 illustrates the comparison of the normalized deposit height (the total volume of the deposit is set to one) obtained experimentally by De Rooij and Dalziel [2001] (dashed line) with that obtained via simulations of embodiments of the invention (solid line). In nondimensional form, the parameters used are: H=2, U₂=0.02, X_{ƒ}=0.75, and Reₚ=1.05, and experiments are nondimensionalized using typical length and time L=13.25 cm and t=1.64 s. The experimental Reynolds number is Re=10,000; simulations were performed with a reduced value Re_{T}=2,200.

Unfortunately, lock-release experiments in which resuspension plays a significant role have not yet been published in the literature. In order to generate sufficiently large current velocities, experiments have only been performed with a constant inflow of particle-laden fluid [Garci´a and Parker, 1993]. At the present time, a model of an embodiment of the invention remains constrained to finite volumes of heavy fluid and one may not directly compare simulations of the invention to experiments where resuspension was significant. However, it may be seen that the size and density (d˜100 μm, ρ̅ₚ˜2.5 g/cm³) of particles subject to re-entrainment at slope angles of order 5° for a current of typical velocity (˜1 m/s) in simulations are commensurate with available experimental data [Garcia and Parker, 1993; Garcia, 1994].

The main discrepancies between experiments and simulations therefore result from either initial or top surface conditions. True turbidity currents typically occur in deep ambients so that the effect of the free surface above is inconsequential. The influence of the height of the computational domain is examined in the next section. The initial velocity of the suspension also differs between experiments and simulations, and is vastly unknown for real turbidity currents. However, the discrepancies resulting from such variations in initial conditions are short-lived. Herein, the concern is with the development of the current at intermediate times, where comparisons with experiments show that models of embodiments of the invention adequately describe the dynamics of the particle-laden gravity currents.

Effect of the Computational Domain Height

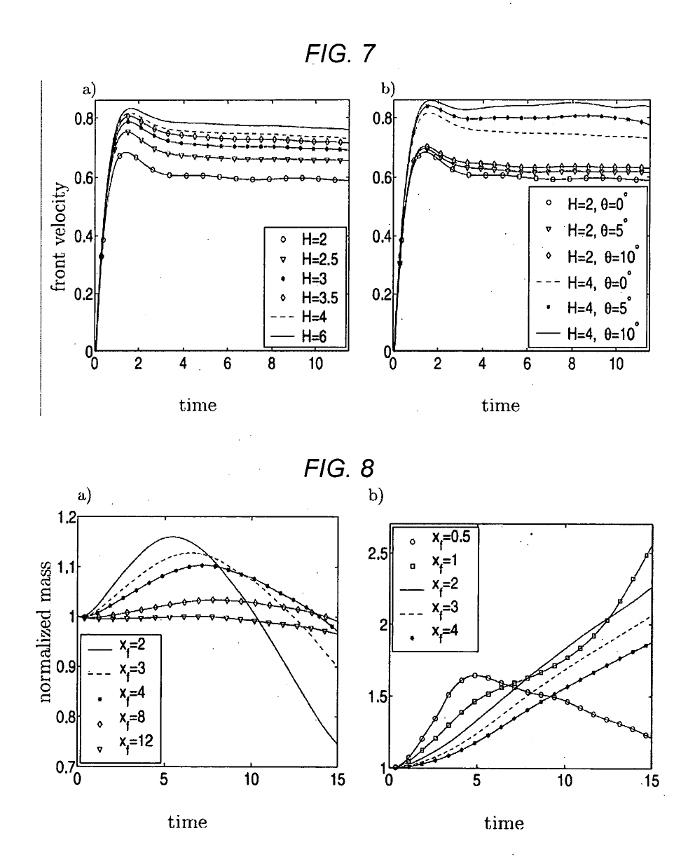

The influence of the computational domain height, H, on the propagation velocity of the current may be examined. Experiments show that light fluid back flow may significantly reduce the velocity of currents spreading in shallow surroundings [Huppert and Simpson, 1980]. FIG. 7A shows the progression of the nose of density currents (Uₛ=0), defined as the furthest point in the x₁ direction where C>0.5, traveling over a flat surface for different values of H. After a brief acceleration period, the velocity of the current's front remains nearly constant over the first 20 nondimensional time units. At longer times, the current decelerates slowly as the height of its head decreases. Currents traveling in deep ambient fluid are not readily affected by the fluid back flow and thus travel faster downstream. Such currents also shed significantly fewer vortices, and therefore dissipate much less energy through viscous effects. It may be seen from FIG. 7a that computations performed with H≧4 are not significantly influenced by the precise value of H and thus may be used to simulate gravity currents in very deep surroundings.

FIG. 7b shows the front velocity, u_{ƒ}, of density currents propagating on slopes of constant angles in both shallow (H=2) and deep (H=4) computational domains. In a deep ambient, the front velocity is known experimentally to increase slightly with slope angle both for constant flux [Britter and Linden, 1980] and constant initial volume [Beghin et al., 1981]. Simulations reveal a similar dependence of u_{ƒ} on the slope angle. After an initial slumping phase, the currents travel at nearly constant speed, u_{ƒ}=0.77 for θ=0°, u_{ƒ}=0.80 for θ=5° and u_{ƒ}=0.83 for θ=10°, showing a nearly linear dependence of the front velocity on θ. Significant mixing between the current and the ambient fluid is observed for large slope angles, reducing the velocity at later times as the size of the head decreases. In a shallow ambient, the slope angle has a negligible impact on the propagation velocity of the current (FIG. 7B). Irrespectively of the slope angle, lighter fluid back flow hinders the progression of the current and generates numerous energy dissipating vortices.

Thus, FIG. 7A illustrates the time dependence of the front velocity, u_{ƒ}, for different values of the computational domain height, H for a fixed initial heavy fluid height of 2. The dependence of the front velocity on H is relatively weak for H≦4. FIG. 7B illustrates the time dependence of the front velocity for different inclination angles θ for both shallow, H=2, and deep, H=4, ambients. In these simulations density currents (Uₛ=0) are considered propagating over a horizontal surface with Re_{T}=Pe_{T}=2,200 and initial length x_{ƒ}=2.

Influence of the Initial Current Length

For resuspending currents, the time evolution of the mass of suspended particles is of primary importance in the description of the flow. If the mass of the currents increases in time, currents which are referred to as self-sustaining, the flow is mostly eroding and may travel for very large distances provided that the inclination angle remains sufficiently large. In contrast, currents traveling along relatively flat surfaces see their mass decrease in time and are mostly depositional. These currents quickly stop spreading as particles are deposited.

The influence of the initial current length, x_{ƒ}, on the time evolution of gravity currents may be examined, and in particular on their self-sustaining quality. FIG. 8A shows the time dependence of the mass of suspended particles of currents propagating over a small inclination angle, θ=3°, such that a current with x_{ƒ}=2 is depositional. The initial mass is normalized to one. The mass of suspended particles first increases briefly during the slumping phase of the current. However, at later times, the settling of particles exceeds resuspension and the total mass decreases. Increasing the initial length is seen to have no qualitative impact on the time dependence of the mass. The initial normalized mass increase is less for longer currents since the amount of resuspended particles near the front is nearly independent of x_{ƒ}.

For a larger slope angle, θ=4°, a current with x_{ƒ}≧1 becomes self-sustaining and its mass increases with time, see FIG. 8B. Once again, the relative mass increase is smaller for longer currents. Notice that very short and tall currents, e.g., with x_{ƒ}=0.5 behave in a qualitatively different manner and appear mostly depositional. The initial length of the current therefore has little impact on whether or not the current will become self-sustaining, provided it is larger than a critical value near x_{ƒ}=1. In the remainder of the simulations presented herein, the initial current length is fixed equal to its initial height at x_{ƒ}=2.

Thus, FIG. 8 illustrates the time dependence of the current mass normalized by the initial mass for various initial length, x_{ƒ}, at two different inclination angles in accordance with one or more embodiments of the invention. In FIG. 8A, the inclination angle is θ=3° and in FIG. 8B, θ=4°. Provided that x_{ƒ}≧1, the long-term behavior of the current appears to be independent of the precise value of x_{ƒ}. In these simulations, deep-water particle-laden currents are considered, H=4, with Uₛ=0.02, Reₚ=3.83, and Re_{T}=Pe_{T}=2,200.

Influence of Resuspension

FIG. 9 shows an example of a strongly resuspending current in accordance with one or more embodiments of the invention. In FIG. 9, the slope angle is sufficiently large, θ=5°, and the particle settling speed sufficiently small, Uₛ=0.02, so that the amount of resuspended particles exceeds that of deposited particles. Unresolved turbulent motions, modeled as a diffusive effect, are responsible for the high concentration observed below x₂≈0.1, while the increase in particle concentration at higher levels is mostly attributable to the advection of the concentration through resolved fluid motions. As the current propagates downslope, its mass and velocity increase. In embodiments of the invention, the only saturation mechanism is the resuspension upper bound Eₛ≦0.3/ C̅₀, so the current may grow until the average particle concentration reaches a level where the average particle-particle interactions may not be neglected ( C̅˜10%) and the model of the invention may no longer apply.

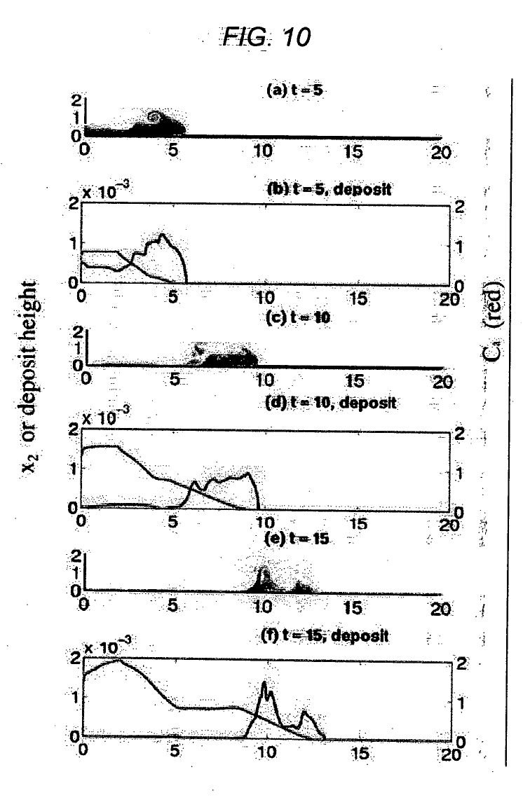

In the early stages of motion (FIG. 9A), the current resembles a noneroding gravity current and only a small boundary layer at the bottom exhibits a larger particle concentration than C̅₀. For comparison, FIG. 10A is included as an example of a current where the flow parameters are identical but resuspension is not taken into account (Eₛ=0). In both cases, mixing with clear fluid dilutes the upper part of the current and the vortices shed behind the front are very similar. In the presence of resuspension, the particle concentration increases near the front and the formation of a massive head is observed (FIGS. 9C and 9E). The volume of the head does not change significantly as the current progresses, but it becomes denser, as illustrated by the integrated concentration profile, Cₐ=∫₀^{H} C dz (displayed in FIGS. 9B, 9D, and 9F). The head becomes progressively heavier as resuspended particles accumulate near the front and it thus propagates faster, generating further erosion.

In the presence of resuspension, particles are deposited near the left wall, but strongly eroded near the initial front position, x_{ƒ}=2, as the initial slumping phase generates vigorous erosion (FIG. 9B). Further downstream, x₁>x_{ƒ}, the erosion pattern is mostly flat in regions behind the current and increases nearly linearly toward the position of the nose of the current. The thin boundary layer preceding the bulk of the current indicates that the erosion process may begin ahead of the front of the current as motions in the ambient fluid are sufficiently vigorous to generate resuspension. The magnitude of the resuspension factor remains nearly constant, Eₛ≈50, and is close to saturation (Eₛ<0.3/ C̅₀=60), in the regions where particle-laden fluid is present. The depth of the eroded region is thus approximately proportional to the time interval during which fluid overlies a given point and depends only weakly on the distance from the source. In the absence of resuspension, see FIGS. 10B, 10D, and 10F, the deposit may only increase in time. The local height of the deposit reflects the time during which the current overlaid a given point.

Thus, FIG. 9 illustrates the evolution of the particle concentration (i.e., in FIGS. 9A, 9C, and 9E) and the evolution of the bed height (i.e., in FIGS. 9B, 9D, and 9F), resuspension factor Eₛ and average concentration Cₐ=∫₀^{H} Cdz, multiplied by 20 for scaling purposes (red lines), of a strongly resuspending gravity current. The color code is: 0.1<C≦0.5 yellow, 0.5<C≦0.8 green, 0.8<C≦1 red, 1<C≦3 cyan, and 3<C black. In FIGS. 9B, 9D, and 9F, the left scale refers to the bed height (solid lines), and the right scale to Eₛ (dashed lines) and 20 Cₐ (red lines). Other parameters are θ=5°, d̅=100 μm, h̅=1.6 m, C̅₀=0.5%, Uₛ=0.02, Re_{T}=Pe_{T}=2,200, x_{ƒ}=2, and H=4.

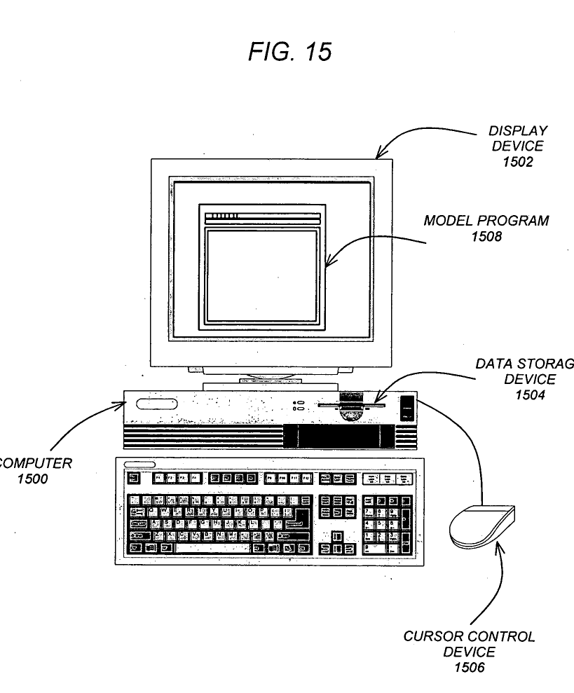

FIG. 10 illustrates the evolution of the particle concentration (i.e., FIGS. 10A, 10C, and 10E) and the evolution of bed height (blue lines) and average concentration Cₐ=∫₀^{H} Cdz (red lines) (i.e., FIGS. 10B, 10D, and 10F), of a nonresuspending gravity current at times t=5 (FIGS. 10A and 10B), 10 (FIGS. 10C and 10D) and 15 (FIGS. 10E and 10F). The color code is 0.1<C≦0.5 yellow, 0.5<C≦0.8 green, and 0.8<C≦1 red. The flow parameters are as in FIG. 9: θ=5°, d̅=100 μm, h̅=1.6 m, C̅₀=0.5%, Uₛ=0.02, Re_{T}=Pe_{T}=2,200, x_{ƒ}=2, and H=4, but the resuspension factor Eₛ has been set to 0.

Dependence of Mass and Velocity on Slope Angle

The slope angle, θ, plays a determinant role in the long term behavior of resuspending currents. For sufficiently large values of θ, the resuspended particles contribute significantly to the potential energy of the current and allow the current to become self-sustaining. FIG. 11 shows the time evolution of the mass of suspended particles (FIG. 11A) and front velocity (FIG. 11B) of currents propagating at different slope angles. In the depositional regime (θ=0°, θ=2°), the mass of the current quickly decreases and shows little dependence on the slope angle. Similarly, the velocity of the front slowly decreases after a brief acceleration period. As particles settle out of suspension, the driving force is reduced and the front velocity decreases earlier than for a corresponding density current, see FIG. 7.

Accordingly, FIG. 11 illustrates time dependence of the normalized mass of suspended particles (i.e., FIG. 11A) and front velocity of currents propagating over slopes of various slope angle (i.e., FIG. 11B). A critical angle may be found, θ_{c}=3.75°, for which θ>θ_{c} gives rise to currents whose mass increases indefinitely and θ<θ_{c} generates depositional currents. Here the flow parameters are Re_{T}=Pe_{T}=2,200, x_{ƒ}=2, H=4, d̅=100 μm, h̅=1.6 m, C̅₀=0.5%, and Uₛ=0.02.

For a larger slope angle (θ=6°), the mass increases in a nearly exponential fashion while it increases almost linearly for an intermediate angle (θ=4°). The slope angle is clearly seen to control the rate of increase, with larger slope angles generating significantly larger entrainment rates. Correspondingly, the front velocity increases with slope angle. As the head becomes denser, the pressure difference between the current and the ambient increases, thus giving rise to a larger driving force. For given flow parameters, there exists a critical slope angle, θ_{c}, above which the mass of the current increases in time and below which all particles eventually settle out. In the next section, the dependence of the critical angle of various flow parameters are examined.

Self-Sustainment Criteria

The conditions under which a gravity current is self-sustaining can be characterized. Only currents propagating in deep ambients, H=4, and with initial aspect ratio equal to one (x_{ƒ}=2) may be considered. The reduced Peclet and Reynolds numbers may be fixed, as well as the particle density and the fluid density and viscosity. The effects of the initial (dimensional) height of heavy fluid, particle concentration and particle radius are examined in detail.

It may first be noted that the particle flux at the lower boundary, F=(−(cos θ)C|ₓ_{₂}₌₀+Eₛ)Uₛ, allows one to readily distinguish between the influence of the particle settling speed, Uₛ, and that of the resuspension factor, Eₛ. One finds that if the resuspension factor is kept constant, the selfsustaining quality of the current is largely unaffected by changes in the particle settling speed. Changes in Uₛ influence the timescale over which particles settle or are resuspended but do not affect the mass balance directly. However, variations in the particle settling speed typically affect Eₛ and therefore, through the resuspension factor, influence the critical self-sustaining angle.

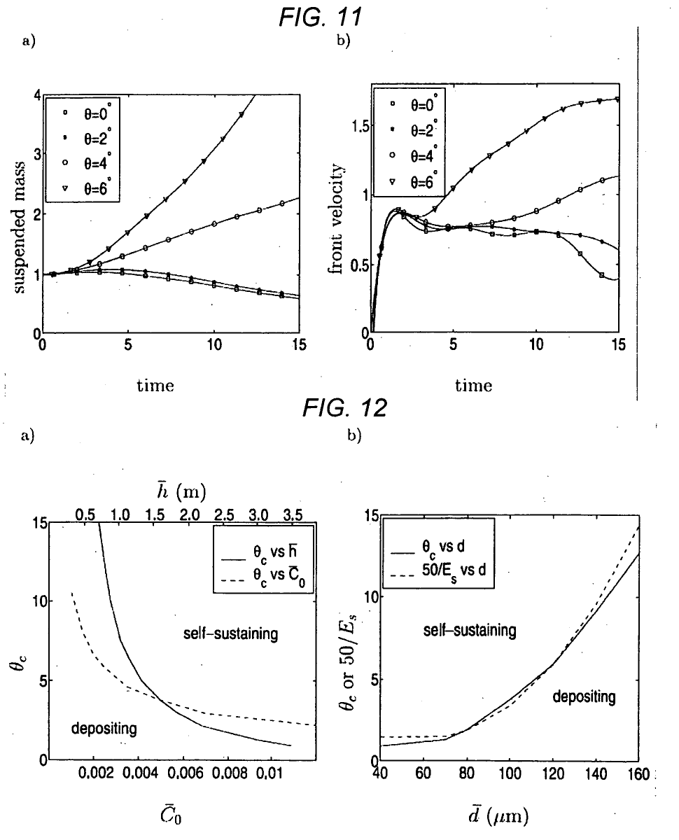

FIG. 12 presents the dependence of the critical slope angle θ_{c} on the heavy fluid height and initial particle concentration in FIG. 12A and particle radius in FIG. 12B. Re_{T}=Pe_{T} is fixed, but all other parameters may be allowed to vary. The dimensional settling speed, buoyancy velocity, particle Reynolds number and resuspension factor are computed using the formulas of Dietrich [1982] and equations (1), (9) and (10), respectively, with varying values of h̅, d̅, and C̅₀. As expected, large critical slope angles are associated to small values of C̅₀ and h̅. As either C̅₀ or h̅ increases, the typical velocity of the current ū_{b}=\sqrt{g} h̅C̅₀R) increases, and currents may thus generate larger bottom shear stresses. In nondimensional form, as the current velocity increases, the settling speed Uₛ diminishes, causing Eₛ to increase. The influence of C̅₀ is weaker than that of h̅; particle re-entrainment will affect low particle concentration currents more readily as the relative particle concentration will then become larger, thus partially counteracting the fact that low values of C̅₀ reduce the current velocity.

FIG. 12B shows that increasing the particle radius renders resuspension more difficult since large particle radii cause Eₛ to decrease. For comparison, the dependence on particle size of a typical value of the inverse of the resuspension factor (50/Eₛ, scaled for plotting purposes) is shown. Both curves are nearly parallel, indicating that Es is the determinant factor in the self-sustaining quality of a current. This underlines the importance of accurately determining Eₛ and in particular the value of Z at which resuspension first becomes important (equation 10), as it will directly influence the value of the critical angle for given flow parameters.

In the parameter regime and for the resuspension factor investigated herein, one may therefore find, by fitting the curves shown in FIGS. 12A and 12B to a power law, that currents are self-sustaining if

$$1 < K \frac{sin {{θ}_{c} ( {\overline{hC}}_{0} )}^{5 / 3}}{{\overline{d}}^{11 / 4} {\overline{C}}_{0}} \approx \frac{sin {θ}_{c}}{sin {3.75}^{°}} \frac{{( \frac{\overline{h}}{1.6 m} \frac{{\overline{C}}_{0}}{0.5 \%} )}^{5 / 3}}{( \frac{{\overline{C}}_{0}}{0.5 \%} ) {( \frac{\overline{d}}{{10}^{- 4} m} )}^{11 / 4}} \qquad ( 11 )$$

where K is a constant determined by the critical angle associated with default parameter values d̅=10⁻⁴ m, h̅=1.6 m and C̅₀=0.005. Turbidity currents may thus be expected to grow in size as long as the inclination angle of the lower boundary is larger than θ_{c}, and to decay over regions where θ<θ_{c}.

Thus, FIG. 12A illustrates dependence of the critical self-sustaining angle θ_{c} on the initial heavy fluid height, h̅, (solid line, top scale) and on the initial particle concentration C̅₀, (dashed line, bottom scale). FIG. 12B illustrates the dependence of the critical angle on particle radius (solid line). For comparison the dependence of 50/Eₛ on a particle radius (dashed line) is shown, where Eₛ is the resuspension factor computed using a typical value of the shear velocity u*=0.13. Currents located above the curves are self-sustaining, while those located below are depositional. The parameters used in these simulations are Re_{T}=Pe_{T}=2,200, x_{ƒ}=2, H=4, d̅=100 μm, C̅₀=0.5%, and h̅=1.6 m. Each of the last three parameters is varied individually while keeping the other two fixed at the value mentioned herein.

Broken Slope Currents

An application of a model to turbidity currents traveling down a slope of varying angle (of an embodiment of the invention) is presented. To simulate the base of the continental slope, a geometry is selected where the initial slope is 5° and the surface away from the source is horizontal. The slope remains constant for x₁<7 and decreases linearly to 0° in the region 7≦x₁<9. The current and particle parameters were chosen to cause the mass of the current to increase over the inclined region.

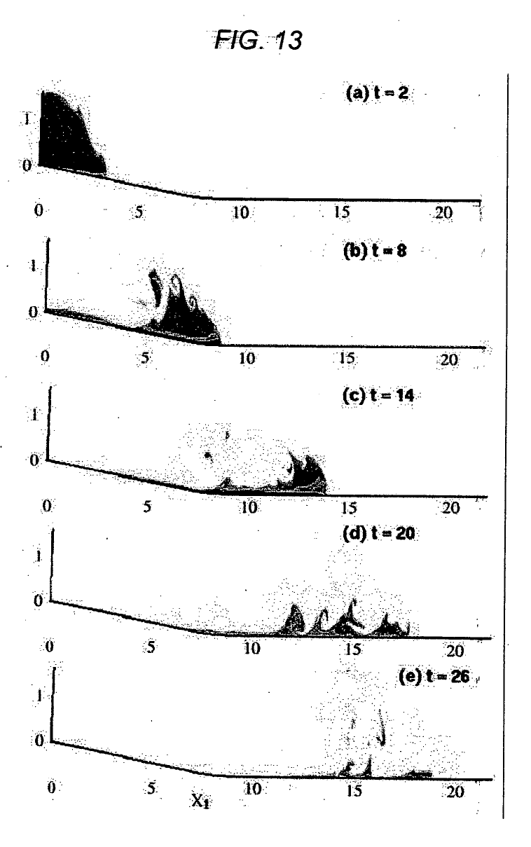

FIG. 13 shows the progression of a current traveling down a broken slope in accordance with one or more embodiments of the invention. In the early stages of motion, the current is erosional and its concentration increases near the lower boundary. However, upon reaching the horizontal bed, the current becomes depositional and eventually comes to rest. The transition from flow over an incline to flow over a horizontal bottom surface occurs smoothly and no significant changes in the height of the current (hydraulic jump) is observed near the corner. The finite volume of heavy fluid presumably prevents the observation of steady hydraulic jumps such as those reported by Garcia [1993].

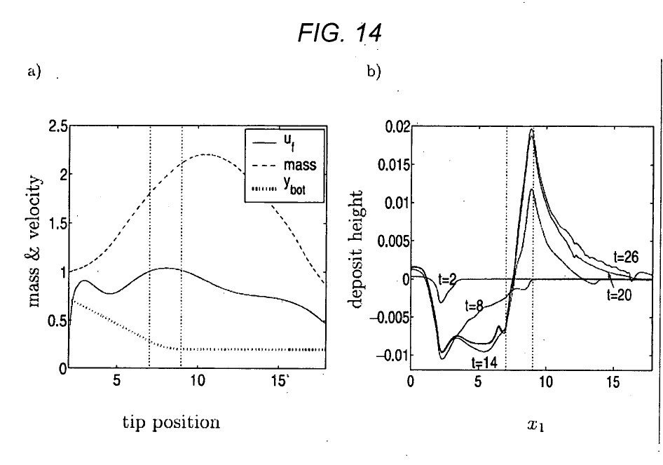

More specifically, FIG. 13 illustrates particle concentration of a resuspending current traveling down a broken slope at times t=2, 8, 14, 20, and 26. The initial slope angle is θ=5°, and the angle decreases linearly to 0 in the region 7≦x₁<9. Corresponding current mass, velocity, and particle deposits may be found in FIG. 14. The color code is: 0.1<C≦0.5 yellow, 0.5<C≦0.8 green, 0.8<C≦1 red, 1<C≦3 cyan, and 3<C black. The flow parameters are, again, d=100 μm, h̅=1.6 m, C̅₀=0.5%, Uₛ=0.02, Re_{T}=Pe_{T}=2,200, x_{ƒ}=2, and H=4.

FIG. 14A illustrates the dependence of the mass of suspended particles and front velocity on the position of the current tip. As the current travels downslope, its mass increases through erosion of the bed. The suspended mass continues to increase even after the nose has reached the flat surface, as most of the heavy fluid is still traveling downhill. At later times, all the heavy fluid overlies a horizontal surface and the current becomes depositional, causing the mass to decrease. The front velocity, after the initial slumping phase, increases while overlying a surface of sufficiently large slope angle. When the nose reaches the corner, the front velocity starts to decrease, showing that the local slope angle readily influences the front velocity. As the current spreads, the velocity keeps decreasing as particles are deposited.

The corresponding deposition pattern is presented in FIG. 14B for different times. Particles are deposited near the left wall before the eroding character of the current develops as it moves downstream. The depth of the eroded region remains constant over the region of large slope angle. Near the corner, the current enters a depositional regime and leaves a deposit of maximum height at the beginning of the flat region. The deposit then decreases with distance from the corner. If a current transports sufficient particles, the geometry of the bottom surface may therefore be significantly altered. In particular, the position of the corner is shifted to the left. The cumulative effect of successive turbidity currents could then displace or create large topographic features and have important geological consequences.

Thus, FIG. 14A illustrates front velocity (solid line) and suspended mass (dashed line) as a function of the position of the nose of a current propagating over a broken slope. The height of the bottom surface is shown as the dotted line. FIG. 14B illustrates dependence of the deposit height on the distance from the left wall at various times for the same current. The region left of the first vertical dotted line has a slope angle of θ=5°, and that right of the second line one of θ=0°. Other flow parameters are Re_{T}=Pe_{T}=2,200, x_{ƒ}=2, H=4, d̅=100 82 m, h̅=1.6 m, Uₛ=0.02, and C̅₀=0.5%.

### Additional Embodiments

In addition to the above described embodiments, additional embodiments of the invention may encompass different or further techniques. For example, larger Reynolds numbers may be used by means of Large Eddy Simulation (LES). Large Eddy Simulation represents a well-established numerical technique in the simulation of turbulent flows. However, the prior art fails to apply LES to the simulation of turbidity currents. Embodiments of the invention perform such an application. In this regard, the application of LES to the simulation of turbidity currents has been successfully validated and tested

In addition, the model of the invention may be used with multiple grain sizes. Such multiple grain size use brings the simulations closer to real world applications, and is based on the explicit tracking of several concentration fields in the flow, one for each grain size. Such an approach provides the ability to study the sorting behavior of turbidity currents, i.e., the manner in which they separate out different particle sizes which then are deposited in more or less distinct layers.

Multiple runs may also be performed. Such multiple runs, in combination with the accounting for variable geometry, provides the ability to investigate how subsequent currents are affected by the erosional and depositional behavior of earlier currents in the same area. In this way, the incremental generation of large sediment deposits by multiple turbidity currents, and the self-organizational characteristics of such sedimentary dynamics can be analyzed.

### Appendix A: Finite-Difference Formula

This appendix illustrates as an example, the formula obtained to estimate the first derivative of a function ƒ for nonconstant Δx₂

$${af}_{l - 1}^{′} + {f}_{i}^{′} + {bf}_{i + 1}^{′} = α {f}_{i - 2} + β {f}_{i - 1} + γ {f}_{i} + δ {f}_{i + 1} + ɛ {f}_{i + 2} , \\ where \\ a = \frac{{x}_{nn} {x}_{p}^{2} {x}_{pp}}{( {x}_{nn} - {x}_{n} ) {( {x}_{n} + {x}_{p} )}^{2} ( {x}_{n} + {x}_{pp} )} , \\ b = \frac{- {x}_{n}^{2} {x}_{nn} {x}_{pp}}{( {x}_{p} - {x}_{pp} ) ( {x}_{nn} + {x}_{p} ) {( {x}_{n} + {x}_{P} )}^{2}} , \\ α = \frac{- {x}_{n}^{2} {x}_{p}^{2} {x}_{pp}}{{( {x}_{n} - {x}_{nn} )}^{2} {{x}_{nn} ( {x}_{nn} + {x}_{p} )}^{2} ( {x}_{nn} + {x}_{pp} )} , \\ ɛ = \frac{{x}_{n}^{2} {x}_{p}^{2} {x}_{nn}}{{( {x}_{p} - {x}_{pp} )}^{2} {{x}_{pp} ( {x}_{n} + {x}_{pp} )}^{2} ( {x}_{nn} + {x}_{pp} )} , \\ β = {x}_{nn} {x}_{p}^{2} {x}_{pp} ( \frac{\begin{matrix}6 {x}_{n}^{3} - 2 {x}_{nn} {x}_{p} {x}_{pp} - {x}_{n}^{2} ( 5 {x}_{nn} ) + {x}_{n}^{2} ( 4 {x}_{p} + 5 {x}_{pp} ) - \\ {x}_{n} ( 3 {x}_{nn} {x}_{p} + 4 {x}_{nn} {x}_{pp} - 3 {x}_{p} {x}_{pp} )\end{matrix}}{\begin{matrix}{{x}_{n} ( {x}_{n} - {x}_{nn} )}^{2} {( {x}_{n} + {x}_{p} )}^{3} {( {x}_{n} + {x}_{pp} )}^{2} \\ {{x}_{n} ( {x}_{n} - {x}_{nn} )}^{2} {( {x}_{n} + {x}_{p} )}^{3} {( {x}_{n} + {x}_{pp} )}^{2}\end{matrix}} ) , \\ δ = {x}_{nn} {x}_{n}^{2} {x}_{pp} ( \frac{\begin{matrix}- 6 {x}_{p}^{3} + 2 {x}_{nn} {x}_{n} {x}_{pp} + {x}_{p}^{2} ( 5 {x}_{pp} ) - {x}_{p}^{2} ( 4 {x}_{n} + 5 {x}_{nn} ) - \\ {x}_{p} ( 3 {x}_{pp} {x}_{n} + 4 {x}_{nn} {x}_{pp} - 3 {x}_{n} {x}_{nn} )\end{matrix}}{\begin{matrix}{{x}_{p} ( {x}_{p} - {x}_{pp} )}^{2} {( {x}_{n} + {x}_{p} )}^{3} {( {x}_{nn} + {x}_{p} )}^{2} \\ {{x}_{p} ( {x}_{p} - {x}_{pp} )}^{2} {( {x}_{n} + {x}_{p} )}^{3} {( {x}_{nn} + {x}_{p} )}^{2}\end{matrix}} ) , \\ γ = \frac{2}{{x}_{n}} + \frac{1}{{x}_{nn}} - \frac{2}{{x}_{p}} - \frac{1}{{x}_{pp}} , \\ {x}_{p} = {x}_{2}^{i + 1} - {x}_{2}^{i} , {x}_{pp} = {x}_{2}^{i + 2} - {x}_{2}^{i} , \\ {x}_{nn} = {x}_{2}^{i} - {x}_{2}^{i - 2} , {x}_{n} = {x}_{2}^{i} - {x}_{2}^{i - 1} . \qquad ( A 1 )$$

Similar formulae may be obtained for second derivative and approximations near and at the boundary.

### Hardware Environment

FIG. 15 is an exemplary hardware and software environment used to implement one or more embodiments of the invention. Embodiments of the invention are typically implemented using a computer 1500, which generally includes, inter alia, a display device 1502, data storage devices 1504, cursor control devices 1506, and other devices. Those skilled in the art will recognize that any combination of the above components, or any number of different components, peripherals, and other devices, may be used with the computer 1500.

One or more embodiments of the invention are implemented by a computer-implemented computational model program 1508, wherein the model program 1508 is represented by a window displayed on the display device 1502. Generally, the model program 1508 comprises logic and/or data embodied in or readable from a device, media, carrier, or signal, e.g., one or more fixed and/or removable data storage devices 1504 connected directly or indirectly to the computer 1500, one or more remote devices coupled to the computer 1500 via a data communications device, etc.

In one or more embodiments, instructions implementing the model program 1508 are tangibly embodied in a computer-readable medium, e.g., data storage device 1504, which could include one or more fixed or removable data storage devices, such as a zip drive, floppy disc drive, hard drive, CD-ROM drive, tape drive, etc. Further, the model program 1508 is comprised of instructions which, when read and executed by the computer 1500, causes the computer 1500 to perform the steps necessary to implement and/or use the present invention. Model program 1508 and/or operating instructions may also be tangibly embodied in a memory and/or data communications devices of computer 1500, thereby making a computer program product or article of manufacture according to the invention. As such, the terms “article of manufacture” and “computer program product” as used herein are intended to encompass a computer program accessible from any computer readable device or media.

Those skilled in the art will recognize that the exemplary environment illustrated in FIG. 15 is not intended to limit the present invention. Indeed, those skilled in the art will recognize that other alternative environments may be used without departing from the scope of the present invention.

### Logical Flow

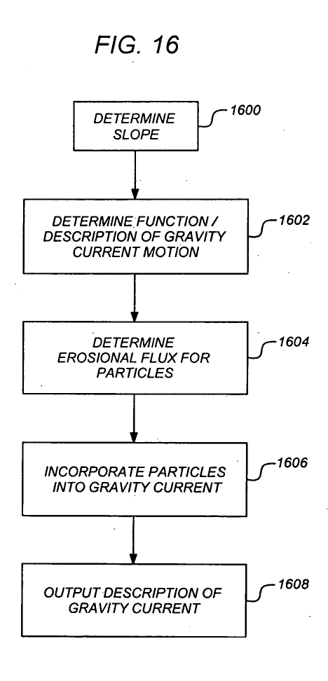

FIG. 16 illustrates the logical flow for determining the effects of resuspending gravity currents in a computer system in accordance with one or more embodiments of the invention. At step 1600, a slope of a geophysical terrain is determined.

At step 1602, a stream function-vorticity description of a fluid motion of a gravity current travelling adjacent to the geophysical terrain is determined.

At step 1604, an erosional flux of particles from the geophysical terrain into the gravity current is determined. As described above, the erosional flux of the particles from the geophysical terrain into the gravity current may be determined in accordance with the following equation:

$$\frac{\partial C}{\partial {x}_{2}} = - {Pe}_{T} {U}_{s} {E}_{s}$$

$$at$$

$${x}_{2} = 0 ,$$

wherein C comprises a concentration of the particles on the geophysical terrain, x₂ comprises a coordinate perpendicular to the slope, Pe_{T} comprises a reduced Peclet number, Uₛ comprises a settling velocity of the particles in the gravity current, and Eₛ comprises an erosion condition for the amount of erosion of the geophysical terrain based on the gravity current. Further, the particles may be multiple different sizes, wherein each particle size is separately tracked in the gravity current.

In addition, the erosional flux of the particles from the geophysical terrain into the gravity current may comprises EₛUₛ as a threshold function of Z in accordance with:

$${E}_{s} = \frac{1}{{\overline{C}}_{0}} \frac{{aZ}^{5}}{1 + \frac{a}{0.3} {Z}^{5}}$$

wherein a comprises 1.3×10⁻⁷.

At step 1606, the particles are incorporated into the gravity current. Such an incorporation may also include the determination of the measure of a vigor of incorporating the particles into the gravity current by calculating Z which is defined as:

$$Z = \frac{{u}^{*}}{{U}_{s}} {Re}_{p}^{0.6} if {Re}_{p} > 2.36 , \\ Z = 0.586 \frac{{u}^{*}}{{U}_{s}} {Re}_{p}^{1.23} if {Re}_{p} \leq 2.36$$

where u* is a shear velocity at a bottom wall of the geophysical terrain and Reₚ is a particle Reynolds number

$${u}^{*} = {( \frac{1}{{Re}_{r}} \frac{\partial u}{\partial {x}_{2}} {\vert}_{x 2 = 0} )}^{1 / 2} , {Re}_{p} = \frac{{\overline{d} ( g \overline{d} R )}^{1 / 2}}{\overline{v}} .$$

Larger Reynolds numbers may also be utilized by conducting a large eddy simulation for the gravity current. Such a large eddy simulation comprises a numerical technique that embodiments of the invention use to simulate turbidity currents.

In addition, steps 1602-1606 may be repeated for multiple different currents thereby allowing the investigation of how subsequent currents are affected by the erosional and depositional behavior of earlier currents in the same area.

At step 1608, a description of the gravity current including the incorporated particles is output. For example, the description may comprise a graphical representation of the gravity current that is displayed on a display device of the computer.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

As described above, a high-resolution simulation model has been developed for resuspending turbidity currents traveling over complex bottom topographies. The model allows for predictions of the erosion and deposition rates of interest in geological and industrial processes. Provided the curvature of the bottom surface remains small, the flexibility of the model allows one to consider such problems as how successive gravity currents are influenced by deposits resulting from earlier currents. Thus, the evolution of large-scale deposit structures may be characterized, which could eventually be used to locate oil and gas fields hosted by turbidites. In particular, embodiments of the invention provide the ability to simulate the spontaneous formation or damping of local bed topography and the evolution of the overall system topography. Validation information has been presented to support the computational approximations required in order to model realistic flows. It was demonstrated that a reduced Reynolds number Re_{T} of O(1000-10,000) is capable of reproducing many of the flow features observed at much larger physical Reynolds numbers inaccessible to direct numerical simulations [Parsons and Garcia, 1998]. The resuspension process is modeled on the basis of the empirical relations determined experimentally by [Garcia and Parker [1993]], by means of a diffusive flux boundary condition at the top of the particle bed. Here the value of the reduced Peclet number Pe_{T} was chosen based on the experimental observations by Garcia [1994]. In the case of self-sustaining currents, it was seen that the qualitative trends, in particular the dependence of the critical self-sustaining angle on particle size or concentration, are independent of the value of Pe_{T}.

For strongly resuspending currents, particle-particle interactions may become important. Currents propagating on a slope of large angle were seen to develop regions where the particle concentration exceeds 5%. The viscosity of the suspension [Huang and Garci´a, 1998], as well as the particle settling speed would then be altered by the presence of neighboring particles [Richardson and Zaki, 1954]. Such effects may not be included in the simulations of embodiments of the invention as an interest was to characterize the onset of self-sustainment, but such effects can be incorporated in simulations aiming to describe high particle concentration currents. A second important aspect is the polydispersity of the suspended particles, which may have a nontrivial influence on the self-sustaining character of a current.

A model of an embodiment of the invention may easily be extended to consider different particle sizes by keeping track of several particle concentrations. The concentration of particles in the bed must also be modeled, since only the topmost particles, the so-called active layer, are available for resuspension [Parker et al., 2000]. Armoring may then occur, where large deposited particles prevent the current from re-entraining smaller underlying particles, which thus prevents further growth of the current [Karim and Kennedy, 1986].

One may also examine the combined effects of polydispersity and repeated flows which can lead to a better understanding of the formation of realistic deposits. Another aspect of the flow not taken into account in the study of an embodiment of the invention is the effect of variations in the spanwise direction. Incorporating such effects requires 3-D simulations, which remain very demanding computationally. However, a model of the invention can be expanded to simulate 3-D flows in a straightforward manner using the approach described by Necker et al. [2003] for density currents. Such capabilities allows one to examine the formation of 3-D structures such as levees, canyons or mini-basins.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

### REFERENCES

Barenblatt, G. I. (1993), Scaling laws for fully-developed turbulent shear flows. 1. Basic hypotheses and analysis, J. Fluid Mech., 248, 513-520.

Beghin, P., E. J. Hopfinger, and R. E. Britter (1981), Gravitational convection from instantaneous sources on inclined boundaries, J. Fluid Mech., 107, 407-422.

Blanchette, F., V. Piche, E. Meiburg, and M. Strauss (2005), Evaluation of a simplified approach simulating gravity currents over slopes of varying angles, Comput. Fluids, in press.

Bonnecaze, R. T., H. E. Huppert, and J. R. Lister (1993), Particle-driven gravity currents, J. Fluid Mech., 250, 339-369.

Bosse, T., L. Kleiser, C. H\ddot{}artel, and E. Meiburg (2005), Numerical simulation of finite Reynolds number suspension drops settling under gravity, Phys. Fluids, 17(3), 037101.

Britter, R. E., and P. F. Linden (1980), The motion of the front of a gravity current traveling down an incline, J. Fluid Mech., 99, 531-543.

Choi, S. U., and M. H. Garci´a (2002), K-_turbulence modeling of density currents developing two dimensionally on a slope, J. Hydrol. Eng., 128, 55-63.

Choi, H. G., and D. D. Joseph (2001), Fluidization by lift of 300 circular particles in plane Poiseuille flow by direct numerical simulation, J. Fluid Mech., 438, 101-128.

de Rooij, F., and S. B. Dalziel (2001), Time and space resolved measurements of deposition under turbidity currents, Spec. Publ. Assoc. Sediment, 31, 207-215.

Dietrich, W. E. (1982), Settling velocity of natural particles, Water Resour. Res., 18(6), 1615-1626.

Elghobashi, S. E., and T. W. Abouarab (1983), A two-equation turbulence model for two-phase flows, Phys. Fluids, 26(4), 931-938.

Fletcher, C. A. J. (1991), Computational Techniques for Fluid Dynamics, vol. 2, 2nd ed., Springer, New York.

Garci´a, M. H. (1993), Hydraulic jumps in sediment-driven bottom currents, J. Hydrol. Eng., 119(10), 1094-1117.

Garci´a, M. H. (1994), Depositional turbidity currents laden with poorly sorted sediment, J. Hydrol. Eng., 120(11), 1240-1263.

Garci´a, M. H., and G. Parker (1991), Entrainment of bed sediment into suspension, J. Hydrol. Eng., 117(4).

Garci´a, M. H., and G. Parker (1993), Experiments on the entrainment of sediment into suspension by a dense bottom current, J. Geophys. Res., 98, 4793-4807.

Hagatun, K., and K. J. Eidsvik (1986), Oscillating turbulent boundary-layer with suspended sediments, J. Geophys. Res., 91, 3045-3055.

H\ddot{}artel, C., E. Meiburg, and F. Necker (2000), Analysis and direct numerical simulation of the flow at a gravity current head. Part 1. Flow topology and front speed for slip and no-slip boundaries, J. Fluid Mech., 418, 189-212.

Hay, A. E., R. W. Burling, and J. W. Murray (1982), Remote acoustic detection of a turbidity current surge, Science, 217, 833-835.

Heezen, B. C., and M. Ewing (1952), Turbidity currents and submarine slumps, and the 1929 Grand-Banks earthquake, Am. J. Sci., 250(12), 849-873.

Hodson, M. E. (1998), The origin of igneous layering in the Nunarssuit Syenite, south Greenland, Min. Mag., 62(1), 9-27.

Hogg, A. J., M. Ungarish, and H. E. Huppert (2000), Particle-driven gravity currents: Asymptotics and box-model solutions, Eur. J. Mech. B Fluids, 19, 139-165.

Hsu, T., J. T. Jenkins, and P. L.-F. Liu (2003), On two-phase sediment transport: Dilute flow, J. Geophys. Res., 108(C3), 3057, doi:10.1029/2001JC001276.

Huang, X., and M. H. Garci´a (1998), A Herschel-Bulkley model for mud flow down a slope, J. Fluid Mech., 374, 305-333.

Hughes-Clarke, J. E., A. N. Shor, D. J. W. Piper, and L. A. Mayer (1990), Large-scale current-induced erosion and deposition in the path of the 1929 Grand Banks turbidity current, Sedimentology, 37, 613-629.

Huppert, H. E., and J. E. Simpson (1980), The slumping of gravity currents, J. Fluid Mech., 99, 785-799.

Hutter, K. (1996), Avalanches, in Hydrology of Disasters, edited by V. P. Singh, chap. 11, pp. 317-393, Springer, New York.

Karim, M. F., and J. F. Kennedy (1986), Degradation of graded-material beds in sediment-deficient rivers, Int. J. Sediment. Res., 1, 39-55.

Krause, D. C., W. C. White, D. J. W. Piper, and B. C. Heezen (1970), Turbidity currents and cable breaks in the Western New Britain trench, Geol. Soc. Am. Bull., 81, 2153-2160.

Lele, S. K. (1992), Compact finite difference schemes with spectral-like resolution, J. Comput. Phys., 103, 16-42.

Necker, F., C. H\ddot{}artel, L. Kleiser, and E. Meiburg (2002), High-resolution simulations of particle-driven gravity currents, Int. J. Multiphase Flow, 28, 279-300.

Necker, F., C. H\ddot{}artel, L. Kleiser, and E. Meiburg (2003), Mixing and dissipation in particle-driven gravity currents, J. Fluid Mech., in press.

Normark, W. R., H. Posamentier, and E. Mutti (1993), Turbidite systems: State of the art and future directions, Rev. Geophys., 31, 91-116.

Pantin, H. M. (1991), A model for ignitive autosuspension in brackish underflows, in Proceedings of the Euromech 262 Colloquium on Sand Transport in Rivers, Estuaries and the Sea, pp. 283-290, A. A. Balkema, Brookfield, Vt.

Pantin, H. M. (2001), In sediment transport and deposition by particulate gravity currents, IAS Spec. Publ. 31, Int. Assoc. Sedimentol.

Parker, G., Y. Fukushima, and H. Pantin (1986), Self-accelerating turbidity currents, J. Fluid Mech., 171, 145-181.

Parker, G., M. H. Garci´a, Y. Fukushima, and W. Yu (1987), Experiments on turbidity currents over an erodible bed, J. Hydrol. Res., 25, 191-244.

Parker, G., C. Paola, and S. Leclair (2000), Probabilistic Exner sediment continuity equation for mixtures with no active layer, J. Hydrol. Eng., 126, 818-826.

Parsons, J. D., and M. H. Garci´a (1998), Similarity of gravity current fronts, Phys. Fluids, 10, 3209-3213.

Patankar, N. A., T. Ko, H. G. Choi, and D. D. Joseph (2001), A correlation for the lift-off of many particles in plane Poiseuille flows of Newtonian fluids, J. Fluid Mech., 445, 55-76.

Pratson, L. F., and B. J. Coakley (1996), A model for the headward erosion of submarine canyons induced by downslope-eroding sediment flows, Geol. Soc. Am. Bull., 108, 225-234.

Richardson, J. F., and W. N. Zaki (1954), Sedimentation and fluidisation: Part I, Trans. Inst. Chem. Eng., 32, 35-53.

Shraiman, B. I., and E. D. Siggia (2000), Scalar turbulence, Nature, 405, 639-646.

Simpson, J. E. (1997), Gravity Currents in the Environment and the Laboratory, 2nd ed., Cambridge Univ. Press, New York.

Smith, J. D., and S. R. McLean (1977), Spatially averaged flow over a wavy surface, J. Geophys. Res., 82, 1735-1746.

Sparks, R. S. J., S. N. Carey, and H. Sigurdsson (1991), Sedimentation from gravity currents generated by turbulent plumes, Sedimentology, 38, 839-856.

Speziale, C. G. (1991), Analytical methods for the developement of Reynolds-stress closures in turbulence, Ann. Rev. Fluid Mech., 23, 107-157.

Spiegel, E. A., and G. Veronis (1960), On the Boussinesq approximation for a compressible fluid, Astrophys. J., 131, 442-447.

Torquato, S., T. Truskett, and P. G. Debenedetti (2000), Is random close packing of spheres well defined?, Phys. Rev. Lett., 84, 2064-2067.

Zeng, J. J., D. R. Lowe, D. B. Prior, W. J. Wiseman, and B. D. Bornhold (1991), Flow properties of turbidity currents in Bute inlet, British Columbia, Sedimentology, 38, 965-996.

Zhang, Y. H., and J. M. Reese (2001), Particle-gas turbulence interactions in a kinetic theory approach to granular flows, Int. J. Mulitphase Flow, 27(11), 1945-1964.

What is claimed is:

1. A method for determining effects of resuspending gravity currents in a computer system, comprising:
determining a slope of a geophysical terrain;
determining a stream function-vorticity description of a fluid motion of a gravity current travelling adjacent to the geophysical terrain;
determining an erosional flux of particles from the geophysical terrain into the gravity current;
incorporating the particles into the gravity current; and
outputting a description of the gravity current including the incorporated particles.

2. The method of claim 1, wherein the outputting comprises displaying a graphical representation of the gravity current including the incorporated particles on a display device.

3. The method of claim 1, wherein the erosional flux of particles from the geophysical terrain into the gravity current is determined in accordance with:
$$\frac{\partial C}{\partial {x}_{2}} = - {Pe}_{T} {U}_{s} {E}_{s} at {x}_{2} = 0 ,$$
wherein C comprises a concentration of the particles on the geophysical terrain, x₂ comprises a coordinate perpendicular to the slope, Pe_{T} comprises a reduced Peclet number, Uₛ comprises a settling velocity of the particles in the gravity current, and E₁ comprises an erosion condition for the amount of erosion of the geophysical terrain based on the gravity current.

4. The method of claim 3, wherein a measure of a vigor of incorporating the particles into the gravity current is given by Z which is defined as:
$$Z = \frac{{u}^{*}}{{U}_{s}} {Re}_{p}^{0.6} if {Re}_{p} > 2.36 , \\ Z = 0.586 \frac{{u}^{*}}{{U}_{s}} {Re}_{p}^{1.23} if {Re}_{p} \leq 2.36$$
where u* is a shear velocity at a bottom wall of the geophysical terrain and Reₚ is a particle Reynolds number
$${u}^{*} = {( \frac{1}{{Re}_{r}} \frac{\partial u}{\partial {x}_{2}} {\vert}_{x 2 = 0} )}^{1 / 2} , {Re}_{p} = \frac{{\overline{d} ( g \overline{d} R )}^{1 / 2}}{\overline{v}} .$$

5. The method of claim 4, wherein the erosional flux of particles from the geophysical terrain into the gravity current comprises EₛUₛ as a threshold function of Z in accordance with:
$${E}_{s} = \frac{1}{{\overline{C}}_{0}} \frac{{aZ}^{5}}{1 + \frac{a}{0.3} {Z}^{5}}$$
wherein a comprises 1.3×10⁻⁷.

6. The method of claim 1, wherein the particles are of multiple different sizes, wherein each particle size is separately tracked in the gravity current.

7. The method of claim 1, further comprising repeating the determining the stream function-vorticity description, determining the erosional flux, and incorporating the particles steps for multiple different currents.

8. The method of claim 1, further comprising conducting a large eddy simulation for the gravity current.

9. An apparatus for determining effects of resuspending gravity currents in a computer system comprising:
(a) a computer having a memory;
(b) an application executing on the computer, wherein the application is configured to:
(i) determine a slope of a geophysical terrain;
(ii) determine a stream function-vorticity description of a fluid motion of a gravity current travelling adjacent to the geophysical terrain;
(iii) determine an erosional flux of particles from the geophysical terrain into the gravity current;
(iv) incorporate the particles into the gravity current; and
(v) output a description of the gravity current including the incorporated particles.

10. The apparatus of claim 9, wherein the application is configured to output by displaying a graphical representation of the gravity current including the incorporated particles on a display device.

11. The apparatus of claim 9, wherein the erosional flux of particles from the geophysical terrain into the gravity current is determined in accordance with:
$$\frac{\partial C}{\partial {x}_{2}} = - {Pe}_{T} {U}_{s} {E}_{s} at {x}_{2} = 0 ,$$
wherein C comprises a concentration of the particles on the geophysical terrain, x₂ comprises a coordinate perpendicular to the slope, Pe_{T} comprises a reduced Peclet number, Uₛ comprises a settling velocity of the particles in the gravity current, and Eₛ comprises an erosion condition for the amount of erosion of the geophysical terrain based on the gravity current.

12. The apparatus of claim 11, wherein a measure of a vigor of incorporating the particles into the gravity current is given by Z which is defined as:
$$Z = \frac{{u}^{*}}{{U}_{s}} {Re}_{p}^{0.6} if {Re}_{p} > 2.36 , \\ Z = 0.586 \frac{{u}^{*}}{{U}_{s}} {Re}_{p}^{1.23} if {Re}_{p} \leq 2.36$$
where u* is a shear velocity at a bottom wall of the geophysical terrain and Reₚ is a particle Reynolds number
$${u}^{*} = {( \frac{1}{{Re}_{r}} \frac{\partial u}{\partial {x}_{2}} {\vert}_{x 2 = 0} )}^{1 / 2} , {Re}_{p} = \frac{{\overline{d} ( g \overline{d} R )}^{1 / 2}}{\overline{v}} .$$

13. The apparatus of claim 12, wherein the erosional flux of particles from the geophysical terrain into the gravity current comprises EₛUₛ as a threshold function of Z in accordance with:
$${E}_{s} = \frac{1}{{\overline{C}}_{0}} \frac{{aZ}^{5}}{1 + \frac{a}{0.3} {Z}^{5}}$$
wherein a comprises 1.3×10⁻⁷.

14. The apparatus of claim 9, wherein the particles are of multiple different sizes, wherein each particle size is separately tracked in the gravity current.

15. The apparatus of claim 9, wherein the application is configured to repeat (ii)-(iv) for multiple different currents.

16. The apparatus of claim 9, wherein the application is further configured to conduct a large eddy simulation for the gravity current.

17. An article of manufacture comprising a program storage medium readable by a computer and embodying one or more instructions executable by the computer to perform a method for determining effects of resuspending gravity currents in a computer system, the method comprising:
determining a slope of a geophysical terrain;
determining a stream function-vorticity description of a fluid motion of a gravity current travelling adjacent to the geophysical terrain;
determining an erosional flux of particles from the geophysical terrain into the gravity current;
incorporating the particles into the gravity current; and
outputting a description of the gravity current including the incorporated particles.

18. The article of manufacture of claim 17, wherein the outputting comprises displaying a graphical representation of the gravity current including the incorporated particles on a display device.

19. The article of manufacture of claim 17, wherein the erosional flux of particles from the geophysical terrain into the gravity current is determined in accordance with:
$$\frac{\partial C}{\partial {x}_{2}} = - {Pe}_{T} {U}_{s} {E}_{s} at {x}_{2} = 0 ,$$
wherein C comprises a concentration of the particles on the geophysical terrain, x₂ comprises a coordinate perpendicular to the slope, Pe_{T} comprises a reduced Peclet number, Uₛ comprises a settling velocity of the particles in the gravity current, and Eₛ comprises an erosion condition for the amount of erosion of the geophysical terrain based on the gravity current.

20. The article of manufacture of claim 19, wherein a measure of a vigor of incorporating the particles into the gravity current is given by Z which is defined as:
$$Z = \frac{{u}^{*}}{{U}_{s}} {Re}_{p}^{0.6} if {Re}_{p} > 2.36 , \\ Z = 0.586 \frac{{u}^{*}}{{U}_{s}} {Re}_{p}^{1.23} if {Re}_{p} \leq 2.36$$
where u* is a shear velocity at a bottom wall of the geophysical terrain and Reₚ is a particle Reynolds number
$${u}^{*} = {( \frac{1}{{Re}_{r}} \frac{\partial u}{\partial {x}_{2}} {\vert}_{x 2 = 0} )}^{1 / 2} , {Re}_{p} = \frac{{\overline{d} ( g \overline{d} R )}^{1 / 2}}{\overline{v}} .$$

21. The article of manufacture of claim 20, wherein the erosional flux of particles from the geophysical terrain into the gravity current comprises EₛUₛ as a threshold function of Z in accordance with:
$${E}_{s} = \frac{1}{{\overline{C}}_{0}} \frac{{aZ}^{5}}{1 + \frac{a}{0.3} {Z}^{5}}$$
wherein a comprises 1.3×10⁻⁷.

22. The article of manufacture of claim 17, wherein the particles are of multiple different sizes, wherein each particle size is separately tracked in the gravity current.

23. The article of manufacture of claim 17, the method further comprising repeating the determining the stream function-vorticity description, determining the erosional flux, and incorporating the particles steps for multiple different currents.

24. The article of manufacture of claim 17, the method further comprising conducting a large eddy simulation for the gravity current.
